(19) United States
(12) Patent Application Publication
(10) Pub. No.: US 2025/0035200 A1
(43) Pub. Date: Jan. 30, 2025

(54) Gear Structure

(71) Applicant: NOK CORPORATION, Tokyo (JP)

(72) Inventor: Naoya IWATA, Tottori (JP)

(21) Appl. No.: 18/776,687

(22) Filed: Jul. 18, 2024

(30) Foreign Application Priority Data
Jul. 27, 2023 (JP) 2023-122301

(51) Int. Cl. F16H 55/14; F16H 57/00

(52) U.S. Cl. CPC F16H 55/14; F16H 57/0006

(57) ABSTRACT

A gear structure includes a gear member including: an outer circumferential surface provided with a plurality of gear teeth; and an inner circumferential surface disposed in an inward direction from the outer circumferential surface; an annular mass body disposed in the inward direction from the inner circumferential surface; and an elastic body interposed between the gear member and the mass body.

### CROSS REFERENCE TO RELATED APPLICATION

This application is based on, and claims priority from, Japanese Patent Application No. 2023-122301, filed on Jul. 27, 2023, the entire contents of which are incorporated herein by reference.

### BACKGROUND

### Technical Field

This disclosure relates to gear structures.

### Related Art

For example, a drive mechanism mounted in a mobile object such as an automobile may have a disadvantage of emitting gear noise such as gear rattling noise caused by impact of gear teeth of a plurality of gears, and gear meshing noise caused by deformation of gear teeth. Japanese Patent Application Laid-Open Publication No. 2014-134230 discloses a configuration in which a gear includes two annular grooves that each accommodate an annular elastic body for absorbing vibrations. One of the two annular grooves is formed on a surface of the gear in an axial direction, and the other of the two annular grooves is formed on a surface of the gear in a direction opposite to the axial direction. However, in the configuration disclosed in Japanese Patent Application Laid-Open Publication No. 2014-134230, since an annular groove is formed on a surface of the gear, a degree of rigidity of the gear is reduced. As a result, there is a disadvantage of reduced reliability of torque transmission. In addition, only the elastic body accommodated in the annular groove cannot sufficiently damp vibrations.

### SUMMARY

An object of one aspect according to this disclosure is to reduce gear noise effectively.

A gear structure according to one aspect of this disclosure includes: a gear member including: an outer circumferential surface provided with a plurality of gear teeth; and an inner circumferential surface disposed in an inward direction from the outer circumferential surface; an annular mass body disposed in the inward direction from the inner circumferential surface; and an elastic body interposed between the gear member and the mass body.

### BRIEF DESCRIPTION OF THE DRAWINGS

FIG. 1 is a plan view of a gear mechanism according to an embodiment.

FIG. 2 is a cross section taken along line II-II shown in FIG. 1.

FIG. 3 is a diagram showing frequency characteristics of operating sounds generated by operation of the gear mechanism.

FIG. 4 is a diagram showing frequency characteristics of operating sounds generated in accordance with operation of the gear mechanism.

### DETAILED DESCRIPTION

An embodiment according to this disclosure will now be described with reference to the accompanying drawings. In each drawing, dimensions and scales of elements may differ from those of actual products. In addition, the embodiment described below is an exemplary embodiment assumed in a case in which this disclosure is implemented. Thus, the scope of this disclosure is not limited to the embodiment described below.

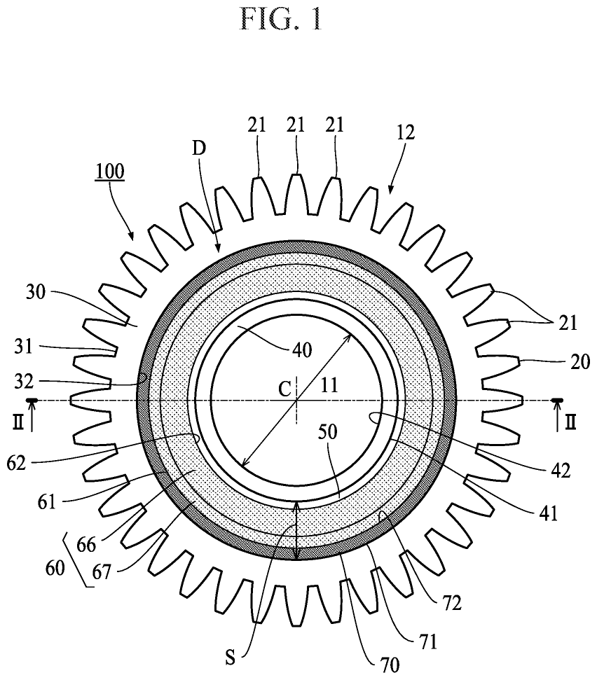

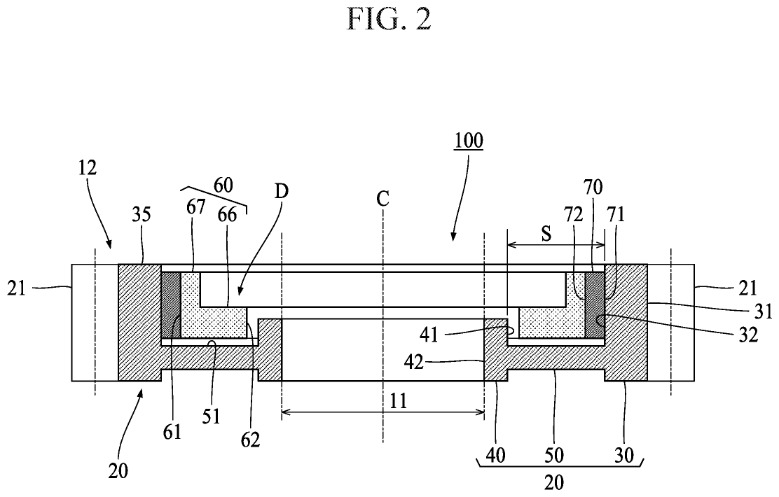

FIG. 1 is a plan view of a gear mechanism 100 according to an embodiment of this disclosure. FIG. 2 is a cross section taken along line II-II shown in FIG. 1. The gear mechanism 100 is, for example, used for a drive mechanism (for example, a transmission or a differential) for transmitting power from a power source, such as an internal combustion engine or an electric motor, to a wheel in a movable object such as an automobile.

As shown in FIG. 1 and FIG. 2, the gear mechanism 100 includes a shaft member 11 and a gear structure 12. The shaft member 11 is a rotatable cylindrical shaft around a rotation axis C. The gear structure 12 is a rotatable body fixed to the shaft member 11. The shaft member 11 can be understood to be an element of the gear structure 12.

In the following description, a virtual circle is assumed that has a freely selected diameter and a center disposed at the rotation axis C. A direction of a circumference of the virtual circle is denoted as a “circumferential direction,” and a direction of a radius of the virtual circle is denoted as a “radial direction.” A direction, which is along the radial direction and toward the rotation axis C, is denoted as an “inward direction.” A direction, which is along the radial direction and away from the rotation axis C, is denoted as an “outward direction.”

As shown in FIG. 1 and FIG. 2, the gear structure 12 includes a gear member 20, a mass body 60, and an elastic body 70. In FIG. 1, for convenience, shading is added to the mass body 60 and the elastic body 70.

The gear member 20 is a disc-shaped spur gear. Specifically, the gear member 20 includes a first portion 30, a second portion 40, and a connecting portion 50. The first portion 30, the second portion 40, and the connecting portion 50 are integrally formed of a material having higher mechanical strength, such as carbon steel for machine structural use (S45C), alloy steel of chrome molybdenum (SCM440, SCM415), and stainless steel (SUS303), for example.

The first portion 30 is an annular portion that includes an outer circumferential surface 31 and an inner circumferential surface 32. The first portion 30 is rotatable around the rotation axis C. The outer circumferential surface 31 is a wall surface of the first portion 30 facing in the outward direction, and the inner circumferential surface 32 is a wall surface disposed in the inward direction from the outer circumferential surface 31. As shown in FIG. 1, the outer circumferential surface 31 of the first portion 30 is provided with a plurality of gear teeth 21 that are equally spaced apart from each other in the circumferential direction. As will be understood from the above description, the gear member 20 is a structure that includes the outer circumferential surface 31, which is provided with the plurality of gear teeth 21, and the inner circumferential surface 32, which is disposed in the inward direction from the outer circumferential surface 31.

As shown in FIG. 1 and FIG. 2, the second portion 40 is an annular portion that includes an outer circumferential surface 41 and an inner circumferential surface 42. The second portion 40 is rotatable around the rotation axis C. The outer circumferential surface 41 is a wall surface of the second portion 40 facing in the outward direction, and the inner circumferential surface 42 is an inner wall surface disposed in the inward direction from the outer circumferential surface 41. An outer diameter of the second portion 40 is less than an inner diameter of the first portion 30. The second portion 40 is disposed in the inward direction from the first portion 30. In other words, the inner circumferential surface 32 of the first portion 30 faces the outer circumferential surface 41 of the second portion 40 across a predetermined space.

The connecting portion 50 is an annular portion interposed between the first portion 30 and the second portion 40. The connecting portion 50 connects the first portion 30 and the second portion 40 to each other. A thickness of the connecting portion 50 is less than a thickness of the first portion 30 (in a direction of the rotation axis C) and is less than a thickness of the second portion 40. Thus, as shown in FIG. 2, an annular space S is formed that is surrounded by the inner circumferential surface 32 of the first portion 30, the outer circumferential surface 41 of the second portion 40, and a surface 51 of the connecting portion 50.

The mass body 60 and the elastic body 70 are accommodated in the space S. In other words, the mass body 60 and the elastic body 70 are interposed between the first portion 30 and the second portion 40. As shown in FIG. 2, the mass body 60 and the elastic body 70 are disposed within a range in the direction of the rotation axis C, the range in the direction of the rotation axis C being between a top surface 35 of the first portion 30 and the surface 51 of the connecting portion 50. Specifically, the mass body 60 and the elastic body 70 face the surface 51 of the connecting portion 50 across a gap. According to the above-described configuration, it is possible to reduce probability of contact between the mass body 60 and the gear member 20. Thus, it is possible to substantially prevent noise (rattling noise) caused by contact between the mass body 60 and the gear member 20. The elastic body 70 may be in contact with the connecting portion 50.

The mass body 60 is a mass damper disposed in the inward direction from the inner circumferential surface 32 of the gear member 20. Specifically, the mass body 60 is a structure made of a highly rigid metallic material such as iron and stainless steel. The mass body 60 is annular and includes an outer circumferential surface 61 and an inner circumferential surface 62.

Specifically, the mass body 60 is a structure in which a body 66 and a protrusion 67 are integrally formed. The body 66 is an annular portion that is rectangular as viewed in transverse plane. The body 66 includes a bottom surface that is not in contact with the surface 51 of the connecting portion 50. However, the bottom surface of the body 66 may be in contact with the surface 51 of the connecting portion 50. The protrusion 67 is an annular portion that protrudes in the direction of the rotation axis C from an outer peripheral edge portion of the body 66. The outer circumferential surface 61 is a wall surface that spreads from the body 66 to the protrusion 67, and the inner circumferential surface 62 is a wall surface of the body 66 facing the inward direction. According to a configuration in which the mass body 60 includes the protrusion 67, it is possible to readily ensure an area of the outer circumferential surface 61 compared to a configuration in which the mass body 60 is constituted of only the body 66.

An outer diameter of the mass body 60 is less than the inner diameter of the first portion 30. The outer circumferential surface 61 of the mass body 60 faces the inner circumferential surface 32 of the first portion 30 across a space. In other words, an entire circumference of the mass body 60 is surrounded by the first portion 30. An inner diameter of the mass body 60 is greater than the outer diameter of the second portion 40. The inner circumferential surface 62 of the mass body 60 faces the outer circumferential surface 41 of the second portion 40 across a space. As described above, the mass body 60 is interposed between the first portion 30 and the second portion 40 of the gear member 20.

The elastic body 70 is a damper spring made of an elastic material such as rubber and resin, for example. Specifically, the elastic body 70 is an annular structure that includes an outer circumferential surface 71 and an inner circumferential surface 72. The elastic body 70 is rotatable around the rotation axis C. The outer circumferential surface 71 is a wall surface of the elastic body 70 facing in the outward direction, and the inner circumferential surface 72 is an inner wall surface disposed in the inward direction from the outer circumferential surface 71.

The elastic body 70 is interposed between the gear member 20 and the mass body 60. Specifically, the elastic body 70 is interposed between the first portion 30 of the gear member 20 and the mass body 60. In other words, the elastic body 70 is interposed between the inner circumferential surface 32 of the gear member 20 and the outer circumferential surface 61 the mass body 60. More particularly, the outer circumferential surface 71 of the elastic body 70 is in close contact with the inner circumferential surface 32 of the gear member 20, and the inner circumferential surface 72 of the elastic body 70 is in close contact with the outer circumferential surface 61 of the mass body 60. As described above, the gear member 20 and the mass body 60 are elastically connected to each other via the elastic body 70. Specifically, the mass body 60 is elastically connected to the first portion 30 of the gear member 20 via the elastic body 70.

In the above-described configuration, the mass body 60 and the elastic body 70 constitute a dynamic vibration absorber D (dynamic damper). The dynamic vibration absorber D is interposed between the first portion 30 and the second portion 40 of the gear member 20. Specifically, the dynamic vibration absorber D is connected to the inner circumferential surface 32 of the first portion 30. The dynamic vibration absorber D absorbs vibrations of the shaft member 11 and vibrations of the gear structure 12 (especially natural vibration components in the radial direction). In other words, it is possible to substantially prevent movement of the shaft member 11 in the radial direction and movement of the gear structure 12 in the radial direction. Thus, it is possible to effectively reduce gear noise caused by rotation of the gear structure 12.

For example, when the shaft member 11 vibrates along the radial direction, gear rattling noise becomes apparent caused by impact of the gear teeth 21 of the gear member 20 against gear teeth of a gear (not shown) that meshes with the gear structure 12. In addition, when the shaft member 11 vibrates in the radial direction in a state in which the gear structure 12 meshes with a gear, the gear teeth 21 of the gear member 20 are deformed by force applied to the gear teeth 21. As a result, gear meshing noise becomes apparent caused by deformation of the gear teeth 21. According to this embodiment, the dynamic vibration absorber D constituted of the mass body 60 and the elastic body 70 absorbs both natural vibrations of the shaft member 11 along the radial direction and natural vibrations of the gear structure 12 along the radial direction. Thus, it is possible to effectively reduce gear noise such as gear rattling noise and gear meshing noise.

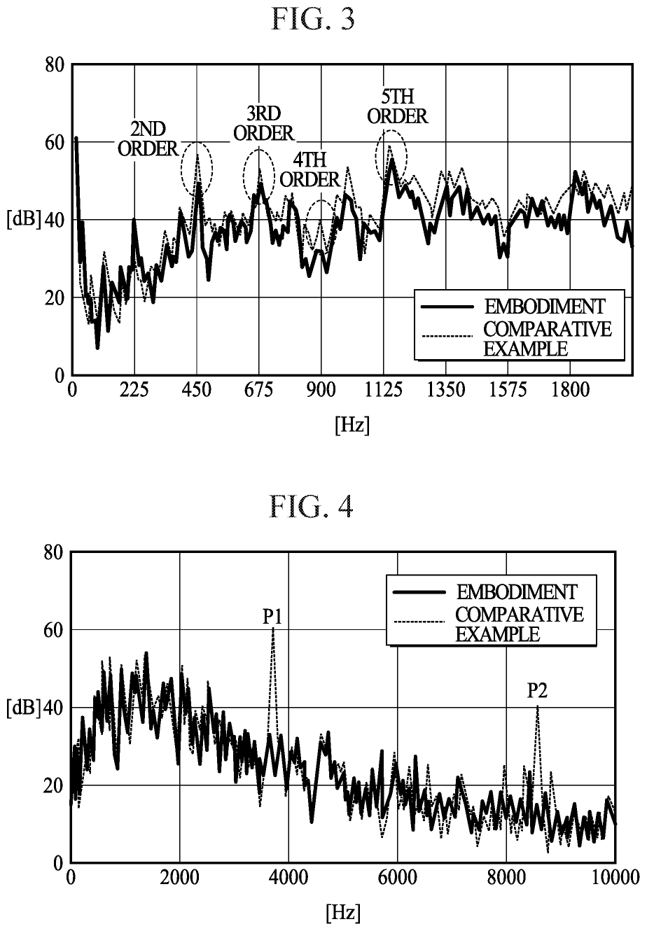

FIG. 3 and FIG. 4 are each a diagram showing frequency characteristics of operating sounds generated in accordance with operation of the gear mechanism 100. FIG. 3 and FIG. 4 each show the frequency characteristics of the operating sounds generated in accordance with operation of the gear mechanism 100 according to this embodiment in which the dynamic vibration absorber D is provided. Furthermore, FIG. 3 and FIG. 4 each show frequency characteristics of operating sounds generated in accordance with operation of a configuration (hereinafter referred to as a “comparative example”) in which the dynamic vibration absorber D is not provided.

FIG. 3 is a diagram showing frequency characteristics of operating sounds caused by vibrations of the gear mechanism 100 along the radial direction. As will be understood from FIG. 3, according to this embodiment including the dynamic vibration absorber D, a peak of an operating sound due to each order vibration mode in the direction along the radial direction is reduced compared to the comparative example. In other words, according to this embodiment, as described above, it is possible to effectively reduce gear noise such as gear rattling noise and gear meshing noise that are each caused by vibrations along the radial direction. As described above, the dynamic vibration absorber D according to this embodiment is constituted so as to reduce vibrations of the gear mechanism 100 along the radial direction.

FIG. 4 is a diagram showing frequency characteristics of operating sounds caused by different vibration modes. As shown in FIG. 4, in the comparative example, a local peak caused by each of the different vibration modes of the gear member 20 is detected from operating sounds. A peak P1 shown in FIG. 4 is a component caused by a vibration mode (curve mode) in which the gear member 20 is curved such that a location of the middle of the gear member 20 in the direction of the rotation axis C is different from a location of a peripheral portion of the gear member 20 in the direction of the rotation axis C. A peak P2 shown in FIG. 4 is a component caused by a vibration mode (expansion and contraction mode) in which the gear member 20 expands and contracts radially in a plane perpendicular to the rotation axis C. As will be understood from FIG. 4, according to this embodiment including the dynamic vibration absorber D, the peak P1 caused by the curve mode and the peak P2 caused by the expansion and contraction mode are reduced compared to the comparative example. In other words, according to this embodiment, it is possible to effectively reduce both gear noise caused by the curve mode and gear noise caused by the expansion and contraction mode. As described above, the dynamic vibration absorber D according to this embodiment is constituted so as to reduce both vibrations of the gear member 20 in the curved mode and vibrations of the gear member 20 in the expansion and contraction mode.

In this embodiment, the inner circumferential surface 32 of the gear member 20 is disposed in the inward direction from the outer circumferential surface 31 provided with the plurality of gear teeth 21, and the mass body 60 is elastically connected to the inner circumferential surface 32 via the elastic body 70. Specifically, the mass body 60 is elastically connected to the inner circumferential surface 32 of the first portion 30 via the elastic body 70. Thus, compared to a configuration in which the mass body 60 is elastically connected to the second portion 40 or to the connecting portion 50, the advantage of the gear noise being reduced is significant.

### B: Modifications

Specific modifications that may be applied to the above-described embodiment are described below. Two or more modifications freely selected from the following modifications may be combined as long as no conflict arises from such combination.
(1) A shape of the mass body 60 may be freely selected and is not limited to the above example. For example, the protrusion 67 of the mass body 60 may be omitted. The mass body 60 may be constituted of a combination of a plurality of elements made of different materials.
(2) A shape of the elastic body 70 may be freely selected and is not limited to the above example. For example, the elastic body 70 may be constituted of a stack of a plurality of layers made of different materials. The elastic body 70 may be constituted of a plurality of different separate elements. For example, the elastic body 70 may be constituted of a plurality of elements disposed in an annular space between the inner circumferential surface 32 of the first portion 30 and the outer circumferential surface 61 of the mass body 60, the plurality of elements being spaced apart from each other in the circumferential direction.
(3) In the above-described embodiment, a configuration is described in which the elastic body 70 is interposed between the mass body 60 and the first portion 30. However, a location at which the elastic body 70 is disposed is not limited to the above example. For example, a configuration is assumed in which the elastic body 70 is interposed between the mass body 60 and the second portion 40. Alternatively, a configuration is assumed in which the elastic body 70 is interposed between the mass body 60 and the connecting portion 50. The elastic body 70 may be interposed between the mass body 60 and each of two or more selected from among the first portion 30, the second portion 40, and the connecting portion 50.
(4) In the above-described embodiment, a configuration is described in which the gear structure 12 is a spur gear. However, this disclosure can be applied to any type of gear such as a bevel gear and a helical gear. A use for the gear mechanism 100 may be freely selected and is not limited to a drive mechanism of a movable object such as an automobile.

### C: Supplemental Notes

The following configurations are derivable from the foregoing embodiments.

A gear structure according to one aspect (first aspect) of this disclosure includes: a gear member including: an outer circumferential surface provided with a plurality of gear teeth; and an inner circumferential surface disposed in an inward direction from the outer circumferential surface; an annular mass body disposed in the inward direction from the inner circumferential surface; and an elastic body interposed between the gear member and the mass body. According to this aspect, the mass body and the elastic body constitute a dynamic vibration absorber. The dynamic vibration absorber absorbs vibrations of the gear structure (especially a natural vibration component in a radial direction). In other words, it is possible to substantially prevent movement of the gear structure in the radial direction. Thus, it is possible to effectively reduce gear noise caused by rotation of the gear structure.

In a specific example (second aspect) of the first aspect, the elastic body is interposed between the inner circumferential surface of the gear member and an outer circumferential surface of the mass body. According to this aspect, the mass body is elastically connected, via the elastic body, to the inner circumferential surface disposed in the inward direction from the outer circumferential surface provided with the plurality of gear teeth. Thus, compared to a configuration in which the mass body is elastically connected to a portion other than the inner circumferential surface of the gear member, the advantage is significant in which gear noise is reduced.

In a specific example (third aspect) of the first aspect, the gear member includes: an annular first portion including the outer circumferential surface and the inner circumferential surface; an annular second portion disposed in the inward direction from the first portion; and an annular connecting portion interposed between the first portion and the second portion, the annular connecting portion connecting the first portion and the second portion to each other, the mass body is interposed between the first portion and the second portion, and the elastic body is interposed between the first portion and the mass body. According to this aspect, the mass body is elastically connected, via the elastic body, to the inner circumferential surface of the first portion provided with the plurality of gear teeth. Thus, compared to a configuration in which the mass body is elastically connected to the second portion, the advantage is significant in which gear noise is reduced.

### DESCRIPTION OF REFERENCE SIGNS

100 . . . gear mechanism, 11 . . . shaft member, 12 . . . gear structure, 20 . . . gear member, 21 . . . gear teeth, 30 . . . first portion, 31 . . . outer circumferential surface, 32 . . . inner circumferential surface, 40 . . . second portion, 41 . . . outer circumferential surface, 42 . . . inner circumferential surface, 50 . . . connecting portion, 51 . . . surface, 60 . . . mass body, 61 . . . outer circumferential surface, 62 . . . inner circumferential surface, 66 . . . body, 67 . . . protrusion, 70 . . . elastic body, 71 . . . outer circumferential surface, 72 . . . inner circumferential surface, D . . . dynamic vibration absorber.

What is claimed is:

1. A gear structure comprising:
a gear member including:
an outer circumferential surface provided with a plurality of gear teeth; and
an inner circumferential surface disposed in an inward direction from the outer circumferential surface;
an annular mass body disposed in the inward direction from the inner circumferential surface; and
an elastic body interposed between the gear member and the mass body.

2. The gear structure according to claim 1, wherein the elastic body is interposed between the inner circumferential surface of the gear member and an outer circumferential surface of the mass body.

3. The gear structure according to claim 1,
wherein the gear member includes:
an annular first portion including the outer circumferential surface and the inner circumferential surface;
an annular second portion disposed in the inward direction from the first portion; and
an annular connecting portion interposed between the first portion and the second portion, the annular connecting portion connecting the first portion and the second portion to each other,
wherein the mass body is interposed between the first portion and the second portion, and
wherein the elastic body is interposed between the first portion and the mass body.
